(19) United States
(12) Patent Application Publication
(10) Pub. No.: US 2007/0275292 A1
(43) Pub. Date: Nov. 29, 2007

(54) Solid Oxide Fuel Cell

(76) Inventors: Agustin Sin Xicola, Carnate (IT); Yuri A. Dubitsky, Milano (IT); Enrico Albizzati, Lesa (IT); Antonino Salvatore Arico, Contesse (IT); Laura Rosalba Gullo, Messina (IT); Daniela La Rosa, Lipari (IT); Vincenzo Antonucci, Messina (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/573,924

(22) PCT Filed: Sep. 30, 2003
(86) PCT No.: PCT/EP03/10821

§ 371 Date: Apr. 24, 2007

(51) Int. Cl. H01M 4/86

(52) U.S. Cl. 429/45; 429/13

(57) ABSTRACT

A solid oxide fuel cell has a cathode, at least an electrolyte membrane, and an anode having a ceramic containing at least one of cobalt and iron, the ceramic being mixed with doped ceria.

The present invention relates to a solid oxide fuel cell and to a method for producing energy by means of a solid oxide fuel cell.

Solid-oxide fuel cells (SOFCs) convert chemical energy into electrical energy with high efficiency and low emission of pollutants. Although the introduction of a “green energy” might seem an attractive scenario, its implementation is beset with technical and economic difficulties.

Common anodes materials for solid oxide fuel cells comprise nickel (Ni) cermets (ceramic and metallic composite materials) with ceramic powders such as yttria-stabilized zirconia (YSZ) or gadolinia-doped ceria (CGO). Ni-cermets perform with H₂ fuels and allow internal steam reforming of hydrocarbons if sufficient water is fed to the anode. As Ni catalyzes the formation of graphite fibers in dry methane, it is necessary to operate anodes at steam/methane ratios greater than 3, as from WO 00/52780 (in the name of Gas Research Institute).

The use of nickel as the metallic component of a cermet anode is advantageous, but its performance drops in short time, especially when fuelled with a dry hydrocarbon, due to graphite formation.

In addition, the poor redox tolerance of nickel cermets precludes many medium- and small-scale applications. Thus there is a considerable interest in finding alternative anode system, as reported by S. Tao e J. T. S Irvine, Nature Materials, 2, 320-323, 2003.

This article relates to a redox-stable efficient anode for SOFC, and investigates complex perovskites based upon Cr and one or more other transition elements (M) such as V, Mn, Fe, Co, Ni, Cu forming compositions (La,Sr)₂M₁₋ₓCr₁₋ₓO_{6-δ}. Samples containing about 50% Co, Ni or Cu were unstable under fuel conditions, with very significant exsolution of metal. This is not surprising because these oxides are unstable, with reduction to the metal under fuel conditions. The stability limit for FeO is very close to fuel conditions; however, MnO is clearly stable under fuel conditions. LSCM (La_{0.75}Sr_{0.25}Cr_{0.5}Mn_{0.5}O₃) is demonstrated as a Ni-free single-phase anode with comparable performance in hydrogen to nickel-YSZ cermets. In contrast with this cermets, the electrode is active for electrooxidation of CH₄ at high temperature in the absence of excess steam (CH₄+3%H₂O).

Perovskite materials are known in the art as being effective as cathode material for SOFC. For example, V. V. Kharton et al., Journal of Materials Science, 36 (2001), 1105-1117 disclose the electrochemical activity of CGO20 (ceria doped with gadolinia at 20% by mole) electrolyte in contact with cathode of perovskite-type La_{0.8}Sr_{0.2}Fe_{0.8}Co_{0.2}O_{3-δ}.

The Applicant has faced the problem of providing a SOFC performing with a variety of fuels, substantially dry hydrocarbons, and especially methane, being included. Such SOFC should perform at low temperature, e.g. 600° C.-800° C., so as to permit the use of cheaper material than those requested for performing at 900° C.-1000° C. Last, but not least, long-term performances (redox stability) for any scale applications are desirable.

Applicant found that the use of FelCo ceramic as anode material provides the SOFC with the desired characteristics of enduring efficiency and energy produced with different fuels, comprising dry hydrocarbons, when mixed with a doped ceria.

The present invention thus relates to a solid oxide fuel cell including a cathode, an anode and at least an electrolyte membrane disposed between said anode and said cathode, wherein said anode comprises a ceramic containing at least one of cobalt and iron, said ceramic being mixed with doped ceria.

Preferably said ceramic has a perovskite structure or a perovskite-related structure.

Preferably the anode of the invention comprises a ceramic containing cobalt and iron.

Examples of ceramic useful for the anode of the invention can have a formula

M₂₋ₓSrₓFe_{2-y}CO_{y}O_{5±δ} wherein M is Ca or a rare earth element; x and y are independently equal to a value comprised between 0 and 2 included, and δ is from stoichiometry; or

MₓS₁₋ₓFe_{1-y}Co_{y}O_{3-δ} Wherein Ms is Ca or a rare earth element; wherein x and y are independently equal to a value comprised between 0 and 0.7 included, and δ, is from stoichiometry.

A ceramic for the anode of the invention can be La_{0.8}Sr_{0.2}FeO₃

Also, a ceramic according to the invention can be a lanthanum strontium cobalt iron oxide having, for example, a general formula La₁₋ₓSrₓCo_{1-y}Fe_{y}O_{3-δ}, wherein x and y are independently equal to a value comprised between 0 and 1 included, and δ is from stoichiometry.

Preferred is a lanthanum strontium cobalt iron oxide of formula La_{0.6}Sr_{0.4}Co_{0.2}Fe_{0.8}O_{3-δ} (hereinafter referred to as LSCF-80).

Preferably, the anode of the present invention is metal-free. With metal-free it is intended that none of the elements present in the anode is in metallic form.

Preferably, the ratio ceramic/doped ceria in the anode ranges from about 50:50 to about 95:5, more preferably from about 60:40 to about 80:20.

Examples of doped ceria useful in the present invention are gadolinia-doped ceria and samaria-doped ceria. Also, ceria can be doped with a cation selected from lanthanum, ytterbium, yttrium, calcium, terbium, neodymium or dysprosium.

The doped cera is preferably doped in an amount of about 20% by mole. Preferred in this connection is Ce_{0.8}Gd_{0.2}O_{1.90} (hereinafter referred to as CGQ-20).

Preferably the doped ceria of the invention has a submicronic particle size. More specifically said particle size is lower than 100 nm.

A cathode for the solid oxide fuel cell of the invention can comprise a ceramic such as La₁₋ₓSrₓMnO_{3-δ}, wherein x and y are independently equal to a value comprised between 0 and 1 included and δ is from stoichiometry, for example a La_{0.6}Sr_{0.4}MnO₃, or La₁₋ₓSrₓCo_{1-y}Fe_{y}O_{3-δ} as disclosed above, optionally combined with a doped ceria. Preferably such ceramic for the cathode is a perovskite structure or a perovskite-related structure.

The electrolyte membrane of the present invention may comprise a doped ceria selected from those listed in connection with the anode composition.

In a SOFC configuration wherein the electrolyte membrane is not supporting, i.e. an electrode supported SOFC, the electrolyte membrane may comprise any kind of suitable ceramic material, for example the above mentioned doped ceria or yttria stabilized zirconia (YSZ).

In another aspect, the present invention relates to a method for producing energy comprising the steps of:

feeding at least one fuel in an anode side of a solid oxide fuel cell comprising an anode comprising a ceramic containing at least one of cobalt and iron, said ceramic being mixed with doped ceria, a cathode and at least an electrolyte membrane disposed between said anode and said cathode;

feeding an oxidant in a cathode side of said solid oxide fuel cell; and

oxidizing said at least one fuel in said solid oxide fuel cell, resulting in production of energy.

Preferably, the at least one fuel is selected from hydrogen; carbon oxide; an alcohol, e.g. methanol, ethanol, propanol; a hydrocarbon in gaseous form, e.g. methane, ethane, propane, butane, natural gas, reformed gas, biogas, syngas and mixture thereof, either in the presence of water or substantially dry; or a hydrocarbon in liquid form, e.g. diesel, toluene, kerosene, jet fuels (JP4, JP-5, JP-8, etc). Preferred for the present invention is substantially dry methane.

As “substantially dry” it is intended that the water content is lower than 100 ppm.

The method of the invention can provide an internal reforming phase at the anode side when an appropriate amount of water is used in combination with a fuel other than hydrogen.

The invention will be further illustrated hereinafter with reference to the following examples and figures, wherein

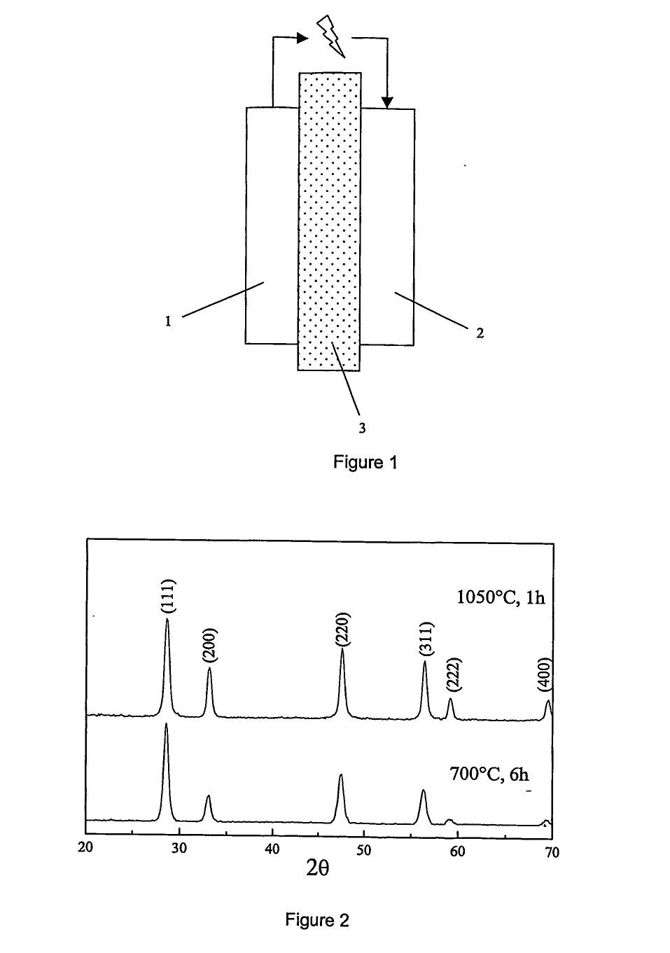

FIG. 1 illustrates a schematic view of a solid oxide fuel cell;

FIG. 2 illustrates X-ray diffraction (XRD) pattern of a CGO-20 powders as prepared in example 1 treated at different temperatures;

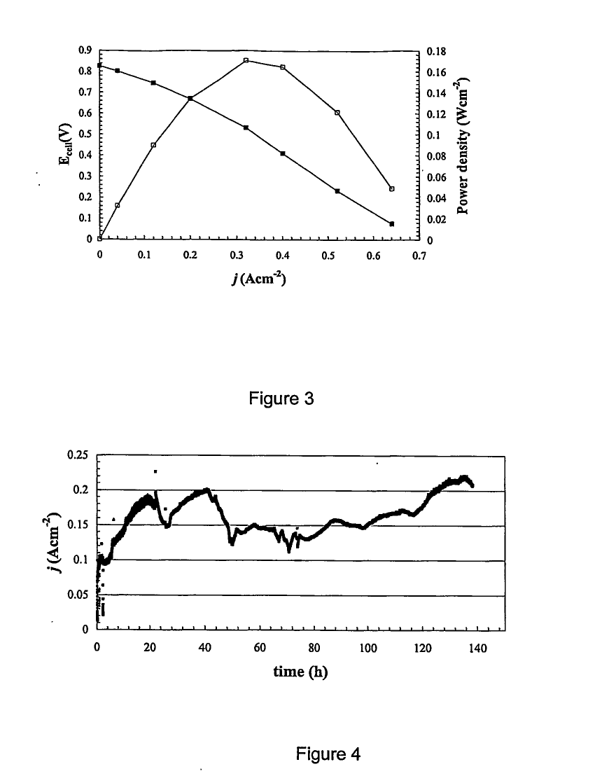

FIG. 3 shows polarization and power density measurements of a cell according to the invention;

FIG. 4 illustrates chronoamperometric evaluation of a cell according to the invention

FIG. 1 schematically illustrates a solid oxide fuel cell comprising anode 1, cathode 2, and electrolyte membrane 3. The arrows indicate the electron flow from anode to cathode during operation.

### EXAMPLE 1

LSCF-CGO-LSCF/CGO

A solid oxide fuel cell with the following structure and composition was prepared and tested:

| | |
|---|---|
| Cathode: | Composition: LSCF-80 |
| | Thickness: ˜20 μm |
| Electrolyte membrane: | Composition: CGO-20 |
| | Thickness: 300 μm |
| Anode: | Composition: 30% wt. of CGO-20 + 70% |
| | wt of LSCF -80 |
| | Thickness: ˜20 μm. |

1. Electrolyte Preparation

a) CGO-20 Powder Synthesis

A solution of 12.6 g of oxalic acid (Aldrich 99.999%) in 250 ml of H₂O was brought to pH=6.5 with NaOH (0.1 M) (Aldrich). 8.0 g. of Ce(NO₃)₃.6H₂O (Aldrich 99.99%) and 2.078 g Gd(NO₃)₃.6H₂O (Aldrich 99.99%) were added to 50 ml of H₂O and stirred up to complete dissolution. This cationic solution was dropwise added to the oxalic solution to give a ratio 1 mol Ce³⁺:˜6 mol H₂C₂O₄ and 1 mol Gd³+:˜6 mol H₂C₂O₄. The formed precipitate was filtered, thrice washed with water and dried at 100° C. for 4 hours. The pH of the water used for washing was up to 6.5. The dried powder was crashed and crystallised at 700° C. for 4 h. A CGO-20 nanopowder (4 g) was obtained. The nano-powder has a particle size of 26 nm measured from the XRD pattern (FIG. 2) by line broadening measurements using the Scherrer equation.

$$t = \frac{K ⨯ λ}{B cos θ}$$

wherein

K is the shape factor of the average crystallite;

l is the wavelength,

β (rad) is the full width at half maximum of an individual peak, and θ (rad) is the peak position (2θ/2).

b) CGO-20 Electrolyte Membrane Preparation.

CGO-20 powder of point a) was thermally treated at 1050° C. for 1 h, then uniaxially, pressed at 300 MPa, and the resulting pellet was thermally treated at 1450° C. for, 6 hours to give a membrane about 300 μm thick, with a relative density (experimental density/theoretical density) higher than 95%.

2. Cathode Preparation

LSFC-80 powder (10 g; single perovskite phase, primary particle mean size 9 nm, BET surface area: 4.12 m²/g, Praxair) was homogenised in a ball milling in 10 ml ethanol for 14 h. Then, is the slurry is diluted and well dispersed in a ultrasonic bath for 4 hours taking 1 g slurry and adding 15 ml of ethanol. The resulting solution was sprayed for 3 min by an aerograph device onto the electrolyte membrane which is maintained at 400° C. Then the cathode and electrode/electrolyte membrane interface were sintered at 1100° C. for 2 hours in air conditions with a heating and cooling ramp of 5° C./min.

3. Anode Preparation

LSFC80 powder (7 g; single perovskite phase, primary particle mean size 9 nm, BET surface area: 4.12 m²/g, Praxair) was homogenised in an agate mortar with CGO-20 (3 g prepared from example 1.a-b) Then, the mixture is ball milled in 10 ml ethanol for 14 h. Then, is the slurry is diluted and well dispersed in a ultrasonic bath for 4 hours taking 1 g slurry and adding 15 ml of ethanol. The resulting solution was sprayed for 3 min by an aerograph device onto the electrolyte membrane which is maintained at 400° C. Then the electrode and electrode/electrolyte membrane interface were sintered at 800° C. for 1 hour and then at 1100° C. for 2 hours in air conditions with a heating and cooling ramp of 5° C./min.

4. Polarisation Measurement.

The cell evaluation was carried out operating at a temperature of 800° C. with substantially dry CH₄. The results are set forth in FIG. 3, wherein the black and blank square represent, respectively, the polarization and the power density curves, respectively. At 0.6V the cell showed a current density close to 0.3 A/cm². The maximum power density reached was 170 mW/cm².

Finally, a chronoamperometric measurement, i.e. the time-variation of the current density of the cell, was effected at 800° C. and 0.6V. The cell was made to perform for 140 h in dry CH₄ and static air (FIG. 4), carrying out several experiments reaching a peak of power density of 140 mW/cm².

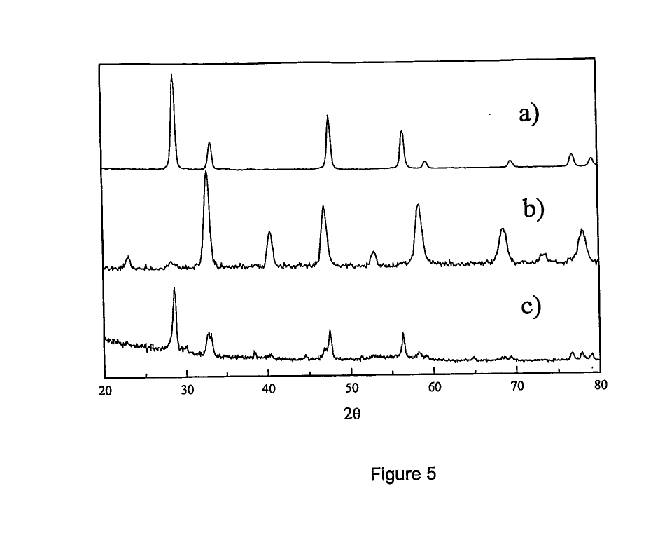

After cooling down the electrochemical cell, the anode was analyzed for verifying its composition and also the presence of carbon. The XRD analysis revealed no significant degradation of the LSCF/CGO anode after 140 h of working time. In FIG. 5, patterns a) and b) respectively show the XRD of pure CGO and LSCFO initial powders as a reference. In FIG. 5, pattern c) is the XRD of the anode material after working for 140 h. All of the three XRD patterns were analyzed using the grazing angle mode (0.5° incidence angle). The grazing angle mode is more sensible to the surface composition (degradation) of the material to be analyzed and can reveal more precisely any trace of carbon deposition. From the XRD analysis can be observed that the. LSCFO and the CGO of the anode after 140 h of working time show no significant degradation. Moreover, there is no presence of carbon deposition which usually appears at 2θ-26.7°. Moreover, the possible presence of carbon was investigated by the elemental CHSN—O analyzer (Carlo Erba). From this analysis no carbon deposition was detected.

This is a very important point in view of the state of the art. S. Tao e J. T. S Irvine supra describe that after running the fuel cell in wet CH₄ at 900° C. for 7 h and cooling down traces of carbon are detected.

Therefore, the combination of the good mixed conducting properties of LSCFO together with the ionic conducting properties of the CGO allows to use this composite as an anode for direct oxidation of dry CH₄ at T≦800° C.

1-30. (canceled)

31. A solid oxide fuel cell comprising a cathode, an anode and at least an electrolyte membrane disposed between said anode and said cathode, said anode comprising a ceramic containing at least one of cobalt and iron, said ceramic being mixed with doped ceria.

32. The solid oxide fuel cell according to claim 31, wherein the ceramic is a perovskite structure or a perovskite-related structure.

33. The solid oxide fuel cell according to claim 31, wherein the ceramic contains cobalt and iron.

34. The solid oxide fuel cell according to claim 31, wherein the ceramic has a formula M₂₋ₓSrₓFe_{2-y}CO_{y}O_{5±δ} wherein M is Ca or a rare earth element; x and y are independently equal to a value of 0 to 2, and δ is from stoichiometry.

35. The solid oxide fuel cell according to claim 31, wherein the ceramic has a formula MₓSr₁₋ₓFe_{1.5-y}CO_{y}O_{3±δ} wherein M is Ca or a rare earth element; wherein x and y are independently equal to a value of 0 to 0.7 and δ is from stoichiometry.

36. The solid oxide fuel cell according to claim 35, wherein the ceramic is La_{0.8}Sr_{0.2}FeO₃.

37. The solid oxide fuel cell according to claim 31, wherein the ceramic is a lanthanum strontium cobalt iron oxide.

38. The solid oxide fuel cell according to claim 37, wherein the lanthanum strontium cobalt iron oxide has a general formula La₁₋ₓSrₓCo_{1-y}Fe_{y}O_{3-δ}, wherein x and y are independently equal to a value of 0 to 1, and δ is from stoichiometry.

39. The solid oxide fuel cell according to claim 38, wherein the lanthanum strontium cobalt iron oxide has a formula La_{0.6}Sr_{0.4}Co_{0.2}Fe0.8O_{3-δ}.

40. The solid oxide fuel cell according to claim 31, wherein the anode is metal free.

41. The solid oxide fuel cell according to claim 31, wherein the ceramic is mixed with the doped ceria in a ceramic/doped ceria ratio of 50:50 to 95:5.

42. The solid oxide fuel cell according to claim 41, wherein the ratio is 60:40 to 80:20.

43. The solid oxide fuel cell according to claim 31, wherein the doped ceria is selected from gadolinia-doped ceria and samaria-doped ceria.

44. The solid oxide fuel cell according to claim 31, wherein ceria is doped with a cation selected from lanthanum, ytterbium, yttrium, calcium, terbium, neodymium or dysprosium.

45. The solid oxide fuel cell according to claim 31, wherein the doped ceria is doped in an amount of about 20% by mole.

46. The solid oxide fuel cell according to claim 31, wherein the doped ceria is Ce_{0.8}Gd_{0.2}O_{1.90}.

47. The solid oxide fuel cell according to claim 31, wherein the doped ceria has a submicronic particle size.

48. The solid oxide fuel cell according to claim 47, wherein the doped ceria has a particle size lower than 100 nm.

49. The solid oxide fuel cell according to claim 31, wherein the cathode comprises a ceramic selected from:
La₁₋ₓSrₓMnO_{3-δ}, wherein x and y are independently equal to a value of 0 to 1, and δ is from stoichiometry; and
La₁₋ₓSrₓCo_{1-y}Fe_{y}O_{3-δ}, wherein x and y are independently equal to a value of 0 to 1, and δ is from stoichiometry.

50. The solid oxide fuel cell according to claim 31, wherein the cathode comprises a doped ceria.

51. The solid oxide fuel cell according to claim 31, wherein the electrolyte comprises a doped ceria.

52. The solid oxide fuel cell according to claim 31, wherein the electrolyte membrane is not supporting.

53. A method for producing energy comprising the steps of:
feeding at least one fuel in an anode side of a solid oxide fuel cell comprising an anode comprising a ceramic containing at least one of cobalt and iron, said ceramic being mixed with doped ceria, a cathode and at least an electrolyte membrane disposed between said anode and said cathode;
feeding an oxidant in a cathode side of said solid oxide fuel cell; and
oxidizing said at least one fuel in said solid oxide fuel cell, resulting in production of energy.

54. The method according to claim 53, wherein the at least one fuel is hydrogen.

55. The method according to claim 53, wherein the at least one fuel is alcohol.

56. The method according to claim 53, wherein the at least one fuel is a hydrocarbon in gaseous form.

57. The method according to claim 56, wherein the hydrocarbon is substantially dry.

58. The method according to claim 53, wherein the at least one fuel is a hydrocarbon in liquid form.

59. The method according to claim 53, wherein the at least one fuel is substantially dry methane.

60. The method according to claim 53, wherein the fuel is internally reformed in the anode side.
